(19) United States
(12) Patent Application Publication
(10) Pub. No.: US 2023/0267519 A1
(43) Pub. Date: Aug. 24, 2023

(54) SYSTEMS AND METHODS FOR IDENTIFYING VISIBLE PORTIONS OF A DOCUMENT IN AN ENVELOPE

(71) Applicant: Change Healthcare Holdings, LLC, Nashville, TN (US)

(72) Inventors: Rhonda L. Lynch, Rock Hill, SC (US); Satyajit Moshat, Howrah (IN)

(21) Appl. No.: 17/680,100

(22) Filed: Feb. 24, 2022

(51) Int. Cl. G06Q 30/04; G06K 19/06

(52) U.S. Cl. CPC G06Q 30/04; G06K 19/06028

(57) ABSTRACT

In an embodiment, systems and methods for displaying regions of a document that will be visible through both a mailing envelope or a return envelope. A document such as a bill is received. The document may be associated with dimensions. A mailing envelope type and a return envelope type are identified. Specification data for the envelopes is retrieved. The specification data may identify location and size information for a window on each envelope. Based on the specification data for the envelopes and the dimensions of the document, a first box and a second box are displayed on the document. The first box may include a portion of the document that will be visible through the window of the mailing envelope and the second box may include a portion of the document that will be visible through the window of the return envelope.

### BACKGROUND

Printed and mailed documents such as bills typically include printed mailing addresses and intelligent mail barcodes that must be visible through a window of a mailing envelope that is used to mail the documents. In addition, the documents may also include corresponding printed return addresses and intelligent mail barcodes that must be visible through a window of an included return envelope.

Because printed documents also often include personal information, such as personal health information, a designer of the printed document must ensure that no personal information is visible through the mailing envelope or the return envelope. However, currently there is no way for a document designer to easily see which portions of a document are visible through windows of envelopes without printing the document and manually inserting the documents into a physical mailing or return envelope or by using a special physical transparency that corresponds to each envelope type. However, physically printing documents is time consuming, and when the specifications of the envelopes are changed, the designer must be provided new physical copies of the documents or new templates, which is inconvenient.

### SUMMARY

In an embodiment, systems and methods for displaying regions of a document that will be visible through one or more windows of a mailing envelope or a return envelope are provided. A document such as a bill is received. The document may be received in an electronic form such as a pdf. The document may be associated with a length and a width. A mailing envelope type and a return envelope type are identified. Specification data for the mailing envelope and the return envelope are retrieved. The specification data may identify location and size information for a window on each envelope. Based on the specification data for the mailing envelope and the return envelope and the length and width of the document, a first box and a second box are displayed on the document. The first box may include a portion of the document that will be visible through the window of the mailing envelope and the second box may include a portion of the document that will be visible through the window of the return envelope. The document including the first and second boxes may be provided as a pdf or other electronic document format.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate systems and methods for annotating documents based on envelope window locations. Together with the description, the figures further serve to explain the principles of the systems and methods for annotating documents based on envelope window locations described herein and thereby enable a person skilled in the pertinent art to make and use the systems and methods for annotating documents based on envelope window locations.

FIG. 1 is an example document annotator for displaying indications on documents that indicate portions of the document that will be visible through windows of one or more envelopes;

FIG. 2 is an illustration of an example envelope;

FIG. 3 is an illustration of an example document;

FIG. 4 is an illustration of an example document with indications showing portions of the document of FIG. 3 that will be visible through windows of one or more envelopes;

FIG. 5 is an illustration of an example method for displaying indications of portions of a document that will be visible through one or more windows of an envelope when inserted into the envelope; and

FIG. 6 shows an exemplary computing environment in which example embodiments and aspects may be implemented.

### DETAILED DESCRIPTION

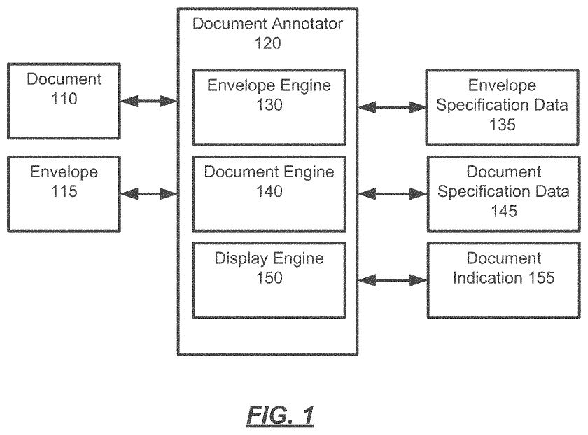

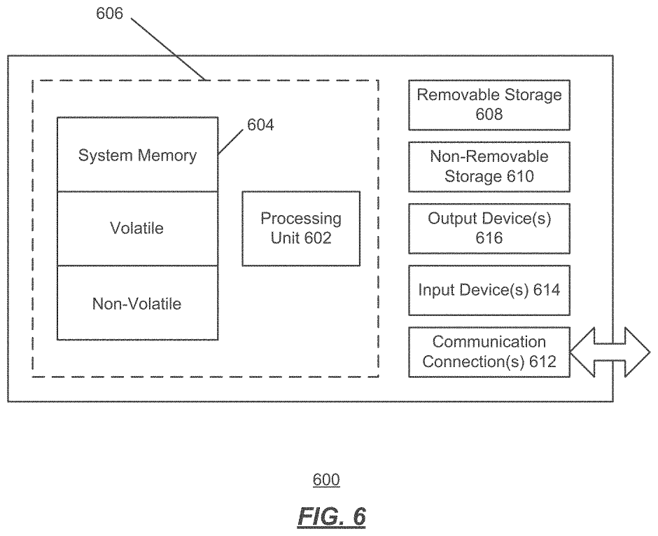

FIG. 1 is an example document annotator for displaying indications on documents that indicate portions of the document that will be visible through windows of one or more envelopes, or other relevant or selected portions of the document. As shown, the document annotator 120 includes one or more components including, but not limited to, an envelope engine 130, a document engine 140, and a display engine 150. Each of the components of the document annotator 120 may be implemented together or separately using one or more general purpose computing devices such as the computing device 600 illustrated with respect to FIG. 6.

The envelope engine 130 may receive envelope specification data 135 about a plurality of envelopes 115. Each envelope 115 may include one or more windows where portions of a document 110 inserted into the the envelope may be visible.

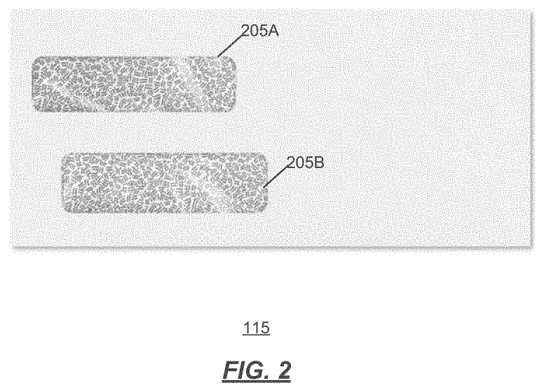

For example, FIG. 2 is an illustration of an example envelope 115 having two windows 205. The window 205A may display portions of a document 110 that show a return address. The window 205B may display portions of the document 110 that show a mailing address. More or fewer windows may be supported.

As may be appreciated, when a document 110 such as a medical bill is inserted into the example envelope 115, it is desirable that the return address be visible through the window 205A and the mailing address be visible through the window 205B. It is also desirable that other information germane to the addresses such as an intelligent mail barcode be visible through the windows 205.

In addition, for documents 110 such as legal documents or medical bills, it is desirable that personal information, such as personal health information, not be visible through any of the windows 205.

To ensure that only correct and necessary information is visible through the windows 205, the received envelope specification data 135 may indicate the size and location of each window 205 on the envelope 115. Depending on the embodiment, the locations may be relative to a common reference point on each envelope 115 such as the top right corner of the envelope 115. Other information may be included in the envelope specification data 135 such as the shape of each window 205 (e.g., rectangle or oval), and a radius of the corners of the window 205.

Each type of envelope 115 may have its own envelope specification data 135. The envelope specification data 135 for a particular type of envelope 115 may be provided by the manufacturer of the envelope 115 and stored by the envelope engine 130. Alternatively or additionally, the envelope specification data 135 for a particular type of envelope 115 may be determined manually by a user or administrator, or by a computing device based on an image or images of the envelope 115.

The document engine 140 may generate document specification data 145 based on the received document 110. The document specification data 145 may include the size of the document 110 (e.g., length and width), and type of document (e.g., first bill document, informational document, letter document, and second or past due notice document). Depending on the embodiment, the size of the document may correspond to one of many standard document sizes such as letter, legal, A4, etc.

The document specification data 145 for a document type may further indicate certain reserved portions of the document 110. These reserved portions of the document 110 are where certain document features are expected to be placed on the document 110. For example, every bill may have a barcode that printed within a reserved portion that uniquely identifies the bill. The barcode must be printed in the reserved portion because that is where an automated document scanning process expects to find the barcode. Other reserved portions may be portions of the document 110 that are expected to kept empty and that no text should appear. Similar to the windows 205, each reserved portion of the document 110 may be defined by a shape and location on the document 110 relative to a location of the document 110 such as the top right corner.

The display engine 150 may display document indications 155 on a document 110 that correspond to portions of the document 110 that may be visible in windows 205 of one or more envelopes 115 and portions of the document 110 that may be reserved portions of the document 110. Depending on the embodiment, the indications 155 may be boxes that are sized based on the corresponding windows 205 and/or reserved portions. The boxes may be colored so that a user or creator of the document 110 may know which indication 155 corresponds to which window 205 or reserved portion.

The display engine 150 may initially receive a document 110 from a user or creator of the document 110. The document 110 may be a medical bill and may be intended to be mailed in a particular envelop 115 (i.e., a mailing envelope). The document 110 may also be intended to be returned in a particular envelope (i.e., a return envelope). The user may have created the document 110 using a word processing or publishing application. The application may be part of, or separate from, the document annotator 120.

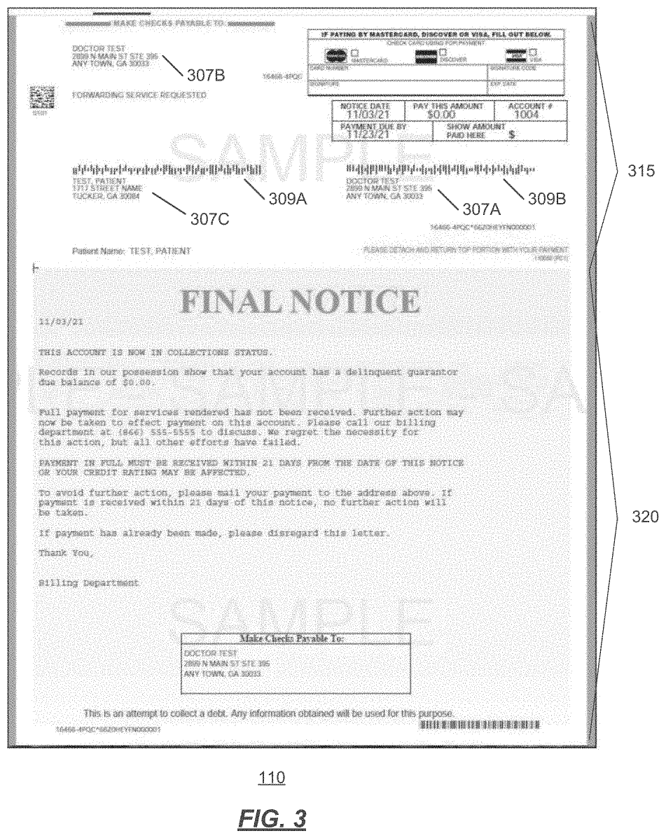

For example, FIG. 3 is an illustration of an example document 110 that may have been created by the user. As shown the document 110 is a medical bill and includes several addresses 307 such as the addresses 307A, 307B, and 307C. The addresses 307B and 307A may be return or billing addresses and may be the address of the entity that is supplying the bill or that should receive payment for the bill. The address 307C may be the mailing address of the patient who will receive the bill. As can be seen, the document 110 includes an area 315 and an area 320. The area 315 is intended to be detached by the recipient from the area 320 and returned in the return envelope 115.

The creator of the document 110 may select the envelope 115 (or envelopes 115) that the document 110 will be mailed in. The display engine 150 may retrieve the envelope specification data 135 corresponding to the selected envelope 115 and the document specification data 145 corresponding to the received document 110, and may use the retrieved data to determine the portions of the document 110 that will be visible in the envelope 115. The display engine 150 may further determine the portions of the document 110 that may be reserved portions.

The document 110 may generate document indications 155 corresponding to the determined portions and may display the indications 155 on top of the document 110. The user may then be able to quickly see what parts of the document 110 will be visible from the windows 205 of the envelope(s) 115 when inserted, and whether any portions of the document 110 are within a reserved portion. Depending on the embodiment, the indications 155 may be colored boxes or highlighted areas.

In some embodiments, the display engine 150 may highlight the text that is visible in each window 205 to the user. Where the display engine 150 detects, using OCR or computer vision, that some parts of an address or intelligent mail barcode may not be completely visible in a window 205, the display engine 150 may alert the user. Similarly, where the display engine 150 determines that private or personal information may be visible in a window 205, the display engine 150 may similarly alert the user. Depending on the embodiment, the display engine 150 may determine the likely private or personal information by searching for key words commonly associated with personal or private information. Alternatively the display engine 150 may use a model trained to identify likely private or personal information.

Continuing the example from FIG. 3, the user may submit the document 110 to the display engine 150 along with indicator of a mailing envelope 115 and a return envelope 115. In response, the display engine 150 may retrieve the envelope specification data 135 for the envelopes 115 and the document specification data 145 for the document 110. The display engine 150 may then calculate the locations of the windows 205 on the document 110 for each envelope 115 as well as the locations of any reserved portions. The display engine 150 may then generate document indications 155 for each window 205 and reserved portion based on the calculated locations.

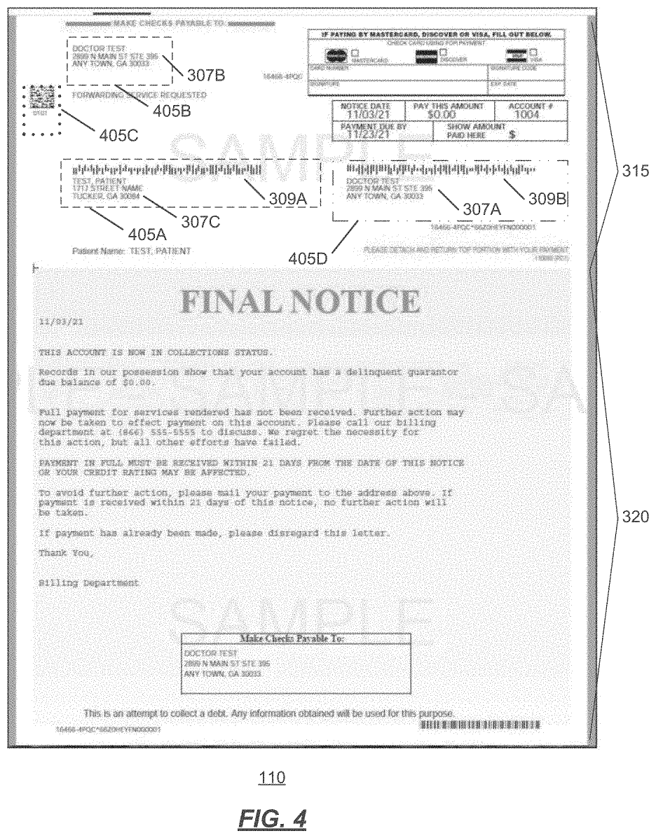

Continuing to FIG. 4, the display engine 150 may render or display the generated document indications 155 on the documents 110. As shown, based on the document of FIG. 3, the display engine 150 has displayed four document indications 155 which are represented by the boxes 405A, 405B, 405C, and 405D. In the example shown, each indication 155 is a box 405 made of hashed or dotted lines, but other types of graphical indications may be used.

The box 405A corresponds to a window 205 of a mailing envelope 115 and shows that both the address 307C (i.e., mailing address) and the intelligent mailing barcode 309A will be visible when the document 110 is placed in the mailing envelope 115 because both are within the boundaries of the box 405A. The box 405B corresponds to another window 205 of the mailing envelope 115 and shows that the address 307B (i.e., return address) will be visible when the document 110 is placed in the mailing envelope 115 because the address 307B is within the boundaries of the box 405B.

The box 405D corresponds to a window 205 of a return envelope 115 and shows that both the address 307A (i.e., mailing address) and the intelligent mailing barcode 309B will be visible when the document 110 is placed in the return envelope 115 because both are within the boundaries of the box 405D. As can be seen, because the box 405D corresponds to the return envelope 115, the box 405D has been rendered using a different hash pattern to distinguish it from the other boxes 405. Depending on the embodiment, the boxes 405 may also be rendered using different colors to show which envelope 115 they correspond to.

The box 405C corresponds to a reserved portion of the document 110. In the example shown, the portion is reserved for a QR code. As can be seen in FIG. 4, the box 405C shows that the QR code of the document 110 will fall within the reserved portion of the document 110. Like the box 405D, the box 405C has similarly been rendered using a different dot pattern to distinguish it from the other boxes 405 that correspond to the windows 205 of the return and mailing envelopes 115.

In addition to verifying that addresses will be visible in the windows 205 of the envelopes 115, the indications 155 also let the user verify that no personal or private information of the addressee will be visible in the windows 205. For example, all of the personal or private information in the document 110 of FIG. 4, such as the fact that the notice is final notice, the amount of the bill, or any information that could indicate the treatment that patient received, is outside of the boxes 405, which indicates that the information is not visible in any window 205.

Note that the document annotator 120 described herein is not limited to annotating documents with indications 155 that correspond to envelopes 155 or envelope windows 205 and may be used more generally to annotate documents 110 using indications 155 of any specified shape or size corresponding to a physical overlay or template.

For example, in one embodiment, after providing a document 110 to the document annotator 120, a user may further specify document specification data 145 (e.g., an excel file) that indicates one or more portions of the document 110. Each indicated portion may be associated with information such as area, shape, and location with respect to the document 110. The document specification data 145 may be based on a physical overlay or template that was previously used to check documents 110.

The document annotator 120 may then render and display a document indication 155 corresponding to each indicated portion in the document specification data 145. Similar to the windows 205, each document indication 155 may be rendered and displayed as a box where the user can see what text or other markings of the document 110 fall within, or are outside of, each indicated portion. In this way, any document 110 editing or creation process that relied on a physical overlay or template with cutouts corresponding to certain document portions or fields can be replaced with the document annotator 120 described herein.

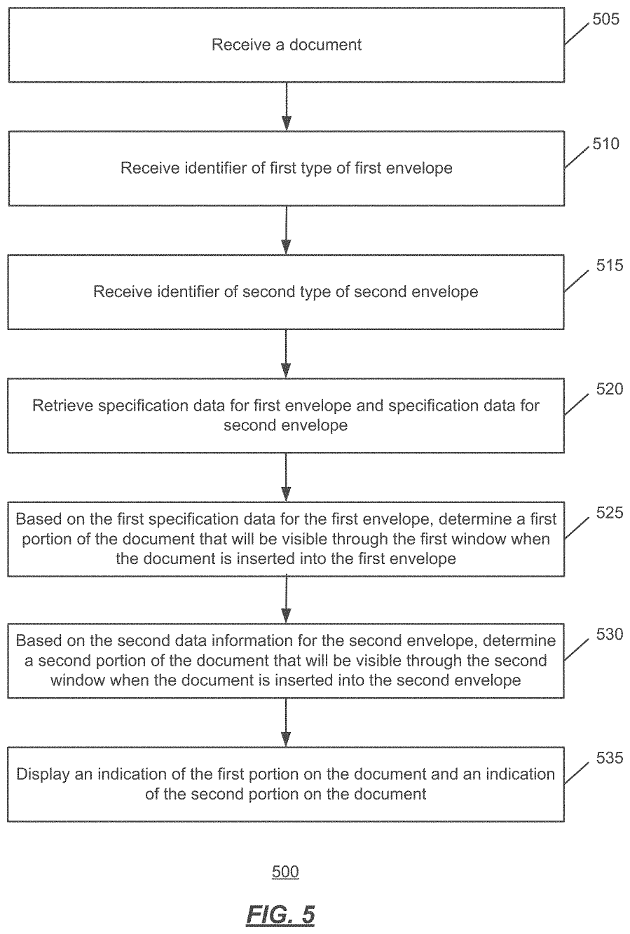

FIG. 5 is an illustration of an example method for displaying indications of portions of a document that will be visible through one or more windows of an envelope when inserted into the envelope. The method 500 may be implemented by the document annotator 120.

At 505, a document is received. The document 110 may be received electronically by the display engine 150. The document 110 may be a medical bill and may be associated with document specification data 145 that includes information such as the dimensions of the document 110 (e.g., height and width). The document specification data 145 may further indicate a particular format or paper size standard used by the document 110 such as letter, A4, etc. The document 110 may include mailing information such as a mailing address, a return address, and intelligent mail barcodes. The document 110 may also include personal and/or private information of a patient or customer. The document 110 may be a PDF document.

At 510, an identifier of a first type of a first envelope is received. The identifier may be received by the display engine 150. The first envelope 115 may be a mailing envelope 115 and may include at least a first window. The identifier of the first type of first envelope may uniquely identify the first envelope from among a plurality of different mailing envelopes. Depending on the embodiment, a creator of the document 110 may have selected the first type of first envelope from a drop down list of mailing envelopes, for example.

At 515, an identifier of a second type of second envelope is received. The identifier may be received by the display engine 150. The second envelope 115 may be a return envelope 115 and may include at least a second window. Depending on the embodiment, the creator of the document 110 may have selected the second type of second envelope from a drop down list of return envelopes, for example.

At 520, specification data about the first and second envelopes is retrieved. The envelope specification data 135 may be retrieved by the display engine 150 according to the identified first and second types. The first envelope specification data 135 may specify the size of the first envelope 115 and the size and location of the first window on the first envelope. The second envelope specification data 135 may specify the size of the second envelope 115 and the size and location of the second window on the second envelope 115. Any other information that could be used to described or represent the size, position, or location of the windows on the envelopes 115 may be included in the envelope specification data 135.

At 525, a first portion of the document that will be visible through the first window when the document is inserted into the first envelope is determined. The first portion may be determined by the display engine 150 using the the first specification data for the first envelope 115 and the document specification data 145.

At 530, a second portion of the document that will be visible through the second window when the document is inserted into the second envelope is determined. The second portion may be determined by the display engine 150 using the the second specification data for the second envelope 115 and the document specification data 145.

At 535, an indication of the first portion on the document and an indication of the second portion on the document are displayed. The document indications 155 may be displayed on the document 110 by the display engine 150. Depending on the embodiment, each indication 155 may be a box that is sized to match the size of a corresponding window of the document 110 relative to the size of the document 110 being displayed. The portion of the document 110 inside of the indication 155 is visible through a corresponding window of an envelope 115, while the portions of the document 110 outside of an indication 155 are not visible through the window. Each indication 155 may be colored or otherwise differentiated so that the user can determine which envelope or window that they correspond to. In some embodiments, the display engine 150 may highlight or bold any text in the document 110 that may be visible through an envelope window based on the locations of the indications 155. In this manner a creator of the document can quickly determine if the text document 110 is suitable for the selected first and second envelopes, or if some of the text should be moved based on the indications 155. Depending on the embodiment, the display engine 150 may output the document 110 and indications as a new electronic document or pdf, for example. Other electronic document formats may be used.

FIG. 6 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a document by a computing device, wherein the document is associated with a length and a width;
receiving an identifier of a first type of a first envelope by the computing device, wherein the first envelope includes a first window;
based on the identified type of the first envelope, retrieving first specification data for the first envelope by the computing device, wherein the first specification data identifies a size and location of the first window on the first envelope;
based on the first specification data for the first envelope, determining a first portion of the document that will be visible through the first window when the document is inserted into the first envelope by the computing device; and
displaying an indication of the first portion on the document by the computing device.

2. The method of claim 1, wherein the document includes a mailing address and an intelligent mail barcode, and further comprising verifying that the mailing address and the intelligent mail barcode are within the first portion.

3. The method of claim 1, wherein the document includes personal health information, and further comprising verifying that no personal health information is visible within the first portion.

4. The method of claim 1, wherein displaying the indication comprises drawing a box around the first portion.

5. The method of claim 1, wherein the first document further comprises a reserved portion, and further comprising displaying an indication of the reserved portion on the document.

6. The method of claim 1, further comprising:
receiving an identifier of a second type of a second envelope by the computing device, wherein the second envelope includes a second window;
based on the identified type of the second envelope, retrieving second specification data for the second envelope by the computing device, wherein the second specification data identifies a size and location of the second window on the second envelope;
based on the second specification data for the second envelope, determining a second portion of the document that will be visible through the second window when the document is inserted into the second envelope by the computing device; and
displaying an indication of the second portion on the document by the computing device.

7. The method of claim 6, wherein the first envelope is a mailing envelope and the second envelope is a return envelope.

8. The method of claim 6, wherein the document includes a mailing address and an intelligent mail barcode, and further comprising verifying that the mailing address and the intelligent mail barcode are within the second portion.

9. The method of claim 6, wherein the document includes personal health information, and further comprising verifying that no personal health information is visible within the second portion.

10. The method of claim 1, wherein the document is a medical bill.

11. A system comprising:
at least one processor; and
a computer-readable medium with computer executable instructions stored thereon that when executed by the computing device cause the computing device to:
receive a document, wherein the document is associated with a length and a width;
receive an identifier of a first type of a first envelope, wherein the first envelope includes a first window;
based on the identified type of the first envelope, retrieve first specification data for the first envelope, wherein the first specification data identifies a size and location of the first window on the first envelope;
based on the first specification data for the first envelope, determine a first portion of the document that will be visible through the first window when the document is inserted into the first envelope; and
display an indication of the first portion on the document.

12. The system of claim 11, wherein the document includes a mailing address and an intelligent mail barcode, and further comprising computer executable instructions that when executed by the computing device cause the computing device to verify that the mailing address and the intelligent mail barcode are within the first portion.

13. The system of claim 11, wherein the document includes personal health information, and further comprising computer executable instructions that when executed by the computing device cause the computing device to verify that no personal health information is visible within the first portion.

14. The system of claim 11, wherein displaying the indication comprises drawing a box around the first portion.

15. The system of claim 11, wherein the first document further comprises a reserved portion, and further comprising computer executable instructions that when executed by the computing device cause the computing device to display an indication of the reserved portion on the document.

16. The system of claim 11, further comprising computer executable instructions that when executed by the computing device cause the computing device to:
receive an identifier of a second type of a second envelope, wherein the second envelope includes a second window;
based on the identified type of the second envelope, retrieve second specification data for the second envelope, wherein the second specification data identifies a size and location of the second window on the second envelope;
based on the second specification data for the second envelope, determine a second portion of the document that will be visible through the second window when the document is inserted into the second envelope; and
display an indication of the second portion on the document.

17. The system of claim 16, wherein the first envelope is a mailing envelope and the second envelope is a return envelope.

18. The system of claim 16, wherein the document includes a mailing address and an intelligent mail barcode, and further comprising computer executable instructions that when executed by the computing device cause the computing device to verify that the mailing address and the intelligent mail barcode are within the second portion.

19. The system of claim 16, wherein the document includes personal health information, and further comprising computer executable instructions that when executed by the computing device cause the computing device to verify that no personal health information is visible within the second portion.

20. A non-transitory computer-readable medium with computer executable instructions stored thereon that when executed by the computing device cause the computing device to:
receive a document, wherein the document is associated with a length and a width;
receive an identifier of a first type of a first envelope, wherein the first envelope includes a first window;
receive an identifier of a second type of a second envelope, wherein the second envelope includes a second window;
based on the identified type of the first envelope, retrieve first specification data for the first envelope, wherein the first specification data identifies a size and location of the first window on the first envelope;
based on the identified type of the second envelope, retrieve second specification data for the second envelope, wherein the second specification data identifies a size and location of the second window on the second envelope;
based on the first specification data for the first envelope, determine a first portion of the document that will be visible through the first window when the document is inserted into the first envelope; and
based on the second specification data for the second envelope, determine a second portion of the document that will be visible through the second window when the document is inserted into the second envelope; and
display an indication of the first portion on the document and an indication of the second portion on the document.

21. A method comprising:
receiving a first document by a computing device electronically;
retrieving specification data, wherein the specification data identifies a plurality of regions and a size and a location of each region;
based on the specification data, rendering each region of the plurality of regions on the first document by the computing device according to the size and location of each region;
generating a second document by the computing device, wherein the second document comprises the first document and each rendered region; and
providing the second document by the computing device electronically.
